(19) United States
(12) Patent Application Publication
(10) Pub. No.: US 2017/0108076 A1
(43) Pub. Date: Apr. 20, 2017

(54) FLUID TYPE POWER TRANSMISSION DEVICE

(71) Applicants: YUTAKA GIKEN CO., LTD., HAMAMATSU-SHI (JP); HONDA MOTOR CO., LTD., TOKYO (JP)

(72) Inventors: Kentaro WATANABE, HAMAMATSU-SHI (JP); Hiroya ABE, HAMAMATSU-SHI (JP); Atsushi KUDO, HAMAMATSU-SHI (JP); Tomoya OKAJI, WAKO-SHI (JP)

(21) Appl. No.: 15/292,298

(22) Filed: Oct. 13, 2016

(30) Foreign Application Priority Data
Oct. 16, 2015 (JP) 2015-204205

(51) Int. Cl. F16F 15/123

(52) U.S. Cl. CPC F16F 15/12366; F16H 41/24

(57) ABSTRACT

A fluid type power transmission device in which a torque transmission path for transmitting torque from a vehicular engine is provided with a dynamic damper mechanism formed by disposing a plurality of damper springs between an inertial rotating body and a rotation-transmitting member forming part of the torque transmission path. An elastic member always linked to one of the rotation-transmitting member and the inertial rotating body is added to the dynamic damper mechanism. Play occurs in a torque direction between the elastic member and the other of the rotation-transmitting member and the inertial rotating body at a time of low speed rotation, but the elastic member exhibits resilient force between the rotation-transmitting member and the inertial rotating body in response to deformation due to centrifugal force at a time of high speed rotation that is a predetermined rotational speed or greater.

### CROSS REFERENCE TO RELATED APPLICATIONS

The present application claims priority under 35 U.S.C. §119 to Japanese Patent Application No. 2015-204205 filed on Oct. 16, 2015 the entire contents of which are hereby incorporated by reference.

### BACKGROUND OF THE INVENTION

Field of the Invention

The present invention relates to a fluid type power transmission device in which a torque transmission path for transmitting torque from a vehicular engine is provided with a dynamic damper mechanism formed by disposing a plurality of damper springs between an inertial rotating body and a rotation-transmitting member forming part of the torque transmission path.

Description of the Related Art

A torque converter, which is a fluid type power transmission device, in which a torque transmission path is provided with a dynamic damper mechanism in a state in which a pump impeller and an output shaft are directly coupled using a lockup clutch is known from Japanese Patent Application Laid-open No. 2009-293671, but in such an arrangement the damping rate of the dynamic damper mechanism is uniquely determined, the rotational speed region in which there is a large damping effect due to the dynamic damper mechanism is limited, and the damping effect over a wide rotational speed region is insufficient.

When solving such a problem, obtaining a damping effect over a wide rotational speed region by changing a spring rate of the dynamic damper mechanism according to a rotational speed could be considered, and such a dynamic damper mechanism is known from for example Japanese Patent Application Laid-open No. 2001-263424 and Japanese Patent Application Laid-open No. 2004-239323.

However, in the arrangement disclosed in Japanese Patent Application Laid-open No. 2001-263424 described above, an inertial rotating body and a drive shaft are linked by means of two link mechanisms, the spring rate is changed by changing an attitude of the two link mechanism accompanying a change in the rotational speed, a structure for changing the spring rate is complicated, the number of components is large, and it is difficult to reduce the cost.

Furthermore, in the arrangement disclosed in Japanese Patent Application Laid-open No. 2004-239323 described above, a damping effect is obtained over a wide region by linking a plurality of dynamic dampers in tandem to a structure that is subjected to damping, but when this technique is applied to a fluid type power transmission device without modification, it leads to an increase in the number of components, thus causing an increase in the cost.

### SUMMARY OF THE INVENTION

The present invention has been accomplished in light of such circumstances, and it is an object thereof to provide a fluid type power transmission device that enables a spring rate of a dynamic damper mechanism to be changed according to a rotational speed by means of a simple structure in which any increase in the number of components is suppressed.

In order to achieve the object, according to a first aspect of the present invention, there is provided a fluid type power transmission device in which a torque transmission path for transmitting torque from a vehicular engine is provided with a dynamic damper mechanism formed by disposing a plurality of damper springs between an inertial rotating body and a rotation-transmitting member forming part of the torque transmission path, wherein an elastic member that, while being capable of deforming when subjected to a centrifugal force, is always linked to either one of the rotation-transmitting member and the inertial rotating body is added to the dynamic damper mechanism, and the elastic member is disposed between the rotation-transmitting member and the inertial rotating body so that play occurs in a torque direction between the elastic member and the other one of the rotation-transmitting member and the inertial rotating body at a time of low speed rotation where torque variation can be absorbed by the damper spring but so that a resilient force is exhibited between the rotation-transmitting member and the inertial rotating body in response to deformation due to centrifugal force at a time of high speed rotation that is a predetermined rotational speed or greater.

In accordance with the first aspect of the present invention, since the elastic member, which is always linked to either one of the rotation-transmitting member and the inertial rotating body while being capable of deforming when subjected to a centrifugal force, is added to the dynamic damper mechanism, and play occurs in the torque direction between the elastic member and the other one of the rotation-transmitting member and the inertial rotating body at the time of low speed rotation where torque variation can be absorbed by the damper spring but the elastic member exhibits a resilient force between the rotation-transmitting member and the inertial rotating body in response to deformation due to centrifugal force at the time of high speed rotation that is a predetermined rotational speed or greater, the spring force of the elastic member is applied to the damper spring at the time of high speed rotation, a resonant frequency of the dynamic damper mechanism shifts toward the high speed rotation side, the spring rate of the dynamic damper mechanism can be changed according to the rotational speed, and in order to realize this only the elastic member is added, thus enabling a simple structure in which any increase in the number of components is suppressed to be achieved.

According to a second aspect of the present invention, in addition to the first aspect, a spring rate of the dynamic damper mechanism having the elastic member is set so that a ratio of the spring rate at the time of high speed rotation relative to the spring rate at the time of low speed rotation is greater than 1 but no greater than 4.

In accordance with the second aspect of the present invention, since the spring rate of the dynamic damper mechanism having the elastic member is set so that the ratio of the spring rate at the time of high speed rotation relative to the spring rate at the time of low speed rotation is greater than 1 but no greater than 4, a damping performance can be enhanced over a wide range of a common rotational speed region of the vehicular engine. That is, since low frequency vibration excited in a low speed rotation region is easily perceived, and an abnormal noise due to the vibration tends to be easily heard, it is possible, by setting the spring rate at a value corresponding to the low speed rotation region, to obtain an effective damping performance over a wide range of the common rotational speed region of the vehicular engine while suppressing the occurrence of low frequency vibration in the low speed rotation region.

According to a third aspect of the present invention, in addition to the first or second aspect, at least two types of elastic members, as said elastic member, are added to the dynamic damper mechanism so that the spring rate of the dynamic damper mechanism is changed for at least two different rotational speeds.

In accordance with the third aspect of the present invention, since at least two types of the elastic members are added to the dynamic damper mechanism, and the spring rate of the dynamic damper mechanism is changed for at least two different rotational speeds by means of these elastic members, it is possible to obtain more effective damping performance in a driving rotational region of the vehicular engine.

According to a fourth aspect of the present invention, in addition to the first aspect, the elastic member is disposed within the inertial rotating body.

In accordance with the fourth aspect of the present invention, since the elastic member is disposed within the inertial rotating body, it is possible to avoid any increase in the dimensions of the dynamic damper mechanism due to addition of the elastic member.

According to a fifth aspect of the present invention, in addition to the first aspect, a pair of rotation-transmitting members, as said rotation-transmitting member, sandwiching at least part of the inertial rotating body from opposite sides are relatively non-rotatably linked so as to form a spring holder holding the damper spring disposed between the rotation-trasmitting members and the inertial rotating body, and the elastic member is disposed within the spring holder.

In accordance with the fifth aspect of the present invention, since the spring holder is formed from the pair of rotation-transmitting members sandwiching at least part of the inertial rotating body from opposite sides, and the elastic member is disposed within the spring holder, it is possible to avoid any increase in the dimensions of dynamic damper mechanism due to the addition of the elastic member.

According to a sixth aspect of the present invention, in addition to the first aspect, the elastic member is formed by bending a plate spring.

According to a seventh aspect of the present invention, in addition to the first aspect, either one of the rotation-transmitting member and the inertial rotating body is always linked to a middle part of the elastic member along a peripheral direction around a rotational axis of the dynamic damper mechanism in a natural state of the elastic member, the elastic member extending in the peripheral direction around the rotational axis, a housing part housing at least part of the elastic member is formed on the other one of the rotation-transmitting member and the inertial rotating body, the housing part is formed from an inner housing portion and an outer housing portion connected to the inner housing portion from an outside along a radial direction with the rotational axis as a center, a length along the peripheral direction of the inner housing portion is set so as to be longer in the peripheral direction than the elastic member in the natural state so as to avoid contact of opposite end parts along the peripheral direction of the inner housing portion with opposite end parts along the peripheral direction of the elastic member at the time of low speed rotation, and a length along the peripheral direction of the outer housing portion is set so as to be shorter in the peripheral direction than the inner housing portion so that opposite end parts along the peripheral direction of the outer housing portion make contact with the opposite end parts along the peripheral direction of the elastic member when the elastic member has been deformed by being subjected to a centrifugal force at the time of high speed rotation.

The above and other objects, characteristics and advantages of the present invention will be clear from detailed descriptions of the preferred embodiments which will be provided below while referring to the attached drawings.

### BRIEF DESCRIPTION OF THE DRAWINGS

FIG. 1 is a longitudinal sectional view of a torque converter of a first embodiment.

FIG. 2 is a front view of a first retaining plate forming part of a spring holder when viewed from a turbine runner side.

FIG. 3 is a diagram showing change in vibration damping rate due to a dynamic damper mechanism according to engine rotational speed.

FIG. 4 is a sectional view showing the vicinity of an elastic member at a time of low speed rotation.

FIG. 5A to FIG. 5D are sectional views showing in sequence change of the elastic member accompanying change in rotational speed.

FIG. 6 is a diagram showing a comparison of frequency characteristics of the dynamic damper mechanism for different spring rates.

FIG. 7 is a diagram showing the frequency characteristics when the spring rate of the dynamic damper mechanism at a time of high speed rotation is made twice that at a time of low speed rotation.

FIG. 8 is a diagram showing the frequency characteristics when the spring rate of the dynamic damper mechanism is a reference example corresponding to that at a time of low speed rotation and when the spring rate is changed to twice, three times, four times, and five times that of the reference example.

FIG. 9 is a diagram showing the frequency characteristics when the spring rate of the dynamic damper mechanism is set at a time of high speed rotation to three times and five times that at a time of low speed rotation.

FIG. 10 is a longitudinal sectional view of a torque converter of a second embodiment.

FIG. 11 is a sectional view along line 11-11 in FIG. 10.

FIG. 12A and FIG. 12B are views respectively showing the operating status of an elastic member at a time of low speed rotation (FIG. 12A) and at a time of high speed rotation (FIG. 12B) when viewed from the direction of arrow 12 in FIG. 10.

FIG. 13 is a longitudinal sectional view of a torque converter of a third embodiment.

FIG. 14 is a front view of a first retaining plate forming part of a spring holder when viewed from a turbine runner side.

FIG. 15 is a diagram showing the frequency characteristics of a dynamic damper mechanism to which two types of elastic members are added.

### DESCRIPTION OF THE PREFERRED EMBODIMENTS

Embodiments of the present invention are explained below by reference to the attached drawings.

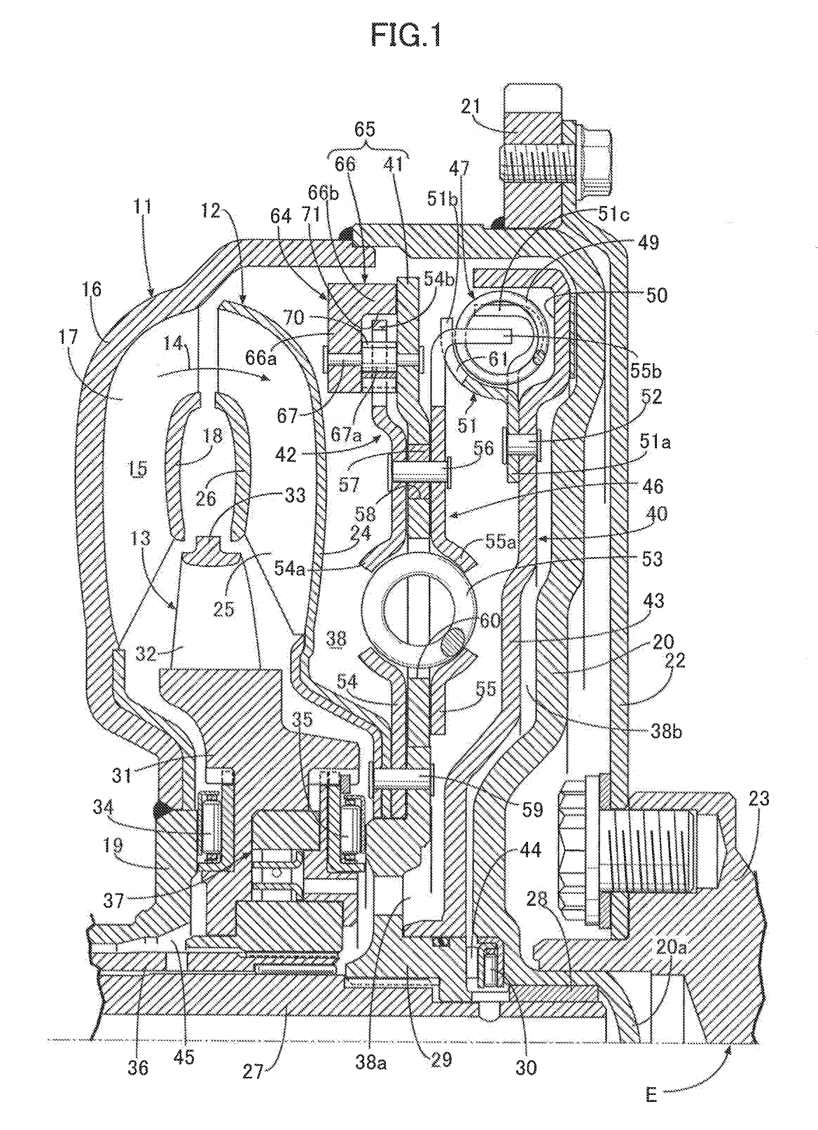

A first embodiment of the present invention is explained by reference to FIG. 1 to FIG. 9; first, in FIG. 1, a torque converter, which is a fluid type power transmission device, includes a pump impeller 11, a turbine runner 12 disposed so as to oppose the pump impeller 11, and a stator 13 disposed between inner peripheral parts of the pump impeller 11 and the turbine runner 12, and a circulation circuit 15 through which hydraulic oil is circulated as shown by an arrow 14 is formed between the pump impeller 11, the turbine runner 12, and the stator 13.

The pump impeller 11 has a bowl-shaped pump shell 16, a plurality of pump blades 17 provided on an inner face of the pump shell 16, a pump core ring 18 linking these pump blades 17, and a pump hub 19 fixed to an inner peripheral part of the pump shell 16 by for example welding, and an oil pump (not illustrated) for supplying hydraulic oil to the torque converter is operatively linked to the pump hub 19.

Furthermore, a bowl-shaped transmission cover 20 covering the turbine runner 12 from the outside is joined to an outer peripheral part of the pump shell 16 by welding, a ring gear 21 is fixed to an outer peripheral part of the transmission cover 20 by welding, and a drive plate 22 is fastened to the ring gear 21. Moreover, a crankshaft 23 of a vehicular engine E is coaxially fastened to the drive plate 22, and rotational power is inputted into the pump impeller 11 from the vehicular engine E.

The turbine runner 12 has a bowl-shaped turbine shell 24, a plurality of turbine blades 25 provided on an inner face of the turbine shell 24, and a turbine core ring 26 linking these turbine blades 25.

An end part of an output shaft 27 that transmits the rotational power from the vehicular engine E to a transmission, which is not illustrated, is supported via a bearing bush 28 on a bottomed cylindrical support tube portion 20a integrally provided on a center part of the transmission cover 20. The output shaft 27 is spline joined to an output hub 29 disposed at a position spaced in the axial direction from the pump hub 19, and a needle thrust bearing 30 is disposed between the output hub 29 and the transmission cover 20.

The stator 13 has a stator hub 31 disposed between the pump hub 19 and the output hub 29, a plurality of stator blades 32 provided on the outer periphery of the stator hub 31, and a stator core ring 33 linking the outer peripheries of the stator blades 32, a thrust bearing 34 is disposed between the pump hub 19 and the stator hub 31, and a thrust bearing 35 is disposed between the output hub 29 and the stator hub 31.

A one-way clutch 37 is disposed between the stator hub 31 and a stator shaft 36 relatively rotatably surrounding the output shaft 27, which rotates together with the output hub 29, and a transmission case (not illustrated) is non-rotatably supported on the stator shaft 36.

Formed between the transmission cover 20 and the turbine shell 24 is a clutch chamber 38 communicating with the circulation circuit 15, and housed within the clutch chamber 38 are a lockup clutch 40, an inertial rotating body 65 rotatably supported on the outer periphery of the output hub 29, and a spring holder 42 holding at least part of the inertial rotating body 65 from opposite sides while being capable of rotating in a restricted range relative to the inertial rotating body 65.

The lockup clutch 40 has a clutch piston 43 that can be frictionally connected to the transmission cover 20, and can switch between a connected state in which the clutch piston 43 is frictionally connected to the transmission cover 20 and a disconnected state in which the frictional connection is released, and an inner peripheral part of the clutch piston 43 formed into a disk shape is slidably supported on the output hub 29 so that it can move in the axial direction.

The interior of the clutch chamber 38 is partitioned by means of the clutch piston 43 into an inner chamber 38a on the turbine runner 12 side and an outer chamber 38b on the transmission cover 20 side, an oil groove 44 formed in the output hub 29 so as to be adjacent to the needle thrust bearing 30 is made to communicate with the outer chamber 38b, and the oil groove 44 communicates with the interior of the output shaft 27, which is cylindrical. Furthermore, an oil passage 45 communicating with an inner peripheral part of the circulation circuit 15 is formed between the pump hub 19 and the stator shaft 36. Connected to the oil groove 44 and the oil passage 45 alternately are the oil pump and an oil reservoir (not illustrated).

When the vehicular engine E is idling or in a very low speed operating region, hydraulic oil is supplied from the oil groove 44 to the outer chamber 38b, and hydraulic oil is guided out from the oil passage 45; in this state the outer chamber 38b has a higher pressure than that of the inner chamber 38a, the clutch piston 43 is pushed toward the side on which it moves away from an inner face of the transmission cover 20, and the lockup clutch 40 is in the disconnected state. In this state, relative rotation of the pump impeller 11 and the turbine runner 12 is allowed, and rotating the pump impeller 11 by means of the vehicular engine E makes hydraulic oil within the circulation circuit 15 circulate within the circulation circuit 15 in the sequence: pump impeller 11, turbine runner 12, and stator 13 as shown by the arrow 14, the rotational torque of the pump impeller 11 being transmitted to the output shaft 27 via the turbine runner 12, the spring holder 42, and the output hub 29.

In a state in which a torque-amplifying action occurs between the pump impeller 11 and the turbine runner 12, a reaction force accompanying it is borne by the stator 13, and the stator 13 is fixed by means of a locking action of the one-way clutch 37. Furthermore, when torque amplification is completed, the stator 13 rotates in the same direction together with the pump impeller 11 and the turbine runner 12 while making the one-way clutch 37 idle by reversing the direction of the torque that the stator 13 receives.

When such a torque converter attains a coupled state or comes close to the coupled state, the connected state between the oil groove 44 and oil passage 45 and the oil pump and oil reservoir is switched over so that hydraulic oil is supplied from the oil passage 45 to the outer chamber 38b and the hydraulic oil is guided out through the oil groove 44. As a result, the pressure in the clutch chamber 38 becomes higher in the inner chamber 38a than in the outer chamber 38b, the clutch piston 43 is pushed toward the transmission cover 20 side by means of the pressure difference, the outer peripheral part of the clutch piston 43 is pressed against the inner face of the transmission case 20 and is frictionally connected to the transmission case 20, and the lockup clutch 40 attains the connected state.

When the lockup clutch 40 attains the connected state, the torque transmitted from the vehicular engine E to the transmission cover 20 is transmitted mechanically to the output hub 29 via a torque transmission path 46 that includes the clutch piston 43 and the spring holder 42, and a damper mechanism 47 is disposed in this torque transmission path 46.

The damper mechanism 47 is formed by disposing a plurality of, for example four, first damper springs 49 between the clutch piston 43 and the spring holder 42, which can rotate relative to each other around the rotational axis, at equal intervals in the peripheral direction.

An annular housing recess 50 is formed in a face, on the side opposite to the transmission case 20, of an outer peripheral part of the clutch piston 43, and a retainer 51 sandwiching between itself and the clutch piston 43 the first damper springs 49 housed within the housing recess 50 at equal intervals in the peripheral direction is fixed to the clutch piston 43.

The retainer 51 is formed so as to integrally have a ring plate portion 51a disposed coaxially with the clutch piston 43 while having an outer periphery substantially corresponding to the inner periphery of the housing recess 50, a spring cover portion 51b formed with an arc-shaped cross section so as to cover the inner side of the first damper spring 49 along the radial direction of the clutch piston 43, provided so as to be connected to four positions at equal intervals in the peripheral direction on the outer periphery of the ring plate portion 51a, and formed lengthwise along the peripheral direction of the clutch piston 43, and a first spring abutment portion 51c disposed between the spring cover portions 51b and provided so as to be connected to the outer periphery of the ring plate portion 51a, the ring plate portion 51a being fixed to the clutch piston 43 by means of a plurality of first rivets 52.

Furthermore, the first spring abutment portion 51c is disposed between the four first damper springs 49, and when the lockup clutch 40 is in the disconnected state, the first spring abutment portion 51c abuts against an end part of each of the first damper springs 49 on opposite sides thereof.

The spring holder 42 is formed from first and second retaining plates 54 and 55, which are rotation-transmitting members forming part of the torque transmission path 46; the first retaining plate 54 is fixed to the output hub 29 together with an inner peripheral part of the turbine shell 24 by means of a plurality of third rivets 59, and the second retaining plate 55 spaced from the first retaining plate 54 in a direction along the axis of the output shaft 27 is relatively non-rotatably linked to the first retaining plate 54 by means of a plurality of second rivets 56.

Moreover, second spring abutment portions 55b are integrally and connectedly provided at a plurality of, for example four, locations spaced at equal intervals in the peripheral direction of the outer periphery of the second retaining plate 55, the second spring abutment portion 55b projecting into the housing recess 50 so as to sandwich the first damper spring 49 between itself and the first spring abutment portion 51c of the retainer 51, and an opening 61 is formed in the spring cover portion 51b of the retainer 51, the second spring abutment portion 55b being inserted through the opening 61 so as to allow relative rotation in a restricted range between the spring cover portion 51b and the second spring abutment portion 55b, that is, the spring holder 42.

When the lockup clutch 40 attains the connected state and the clutch piston 43 and the retainer 51 rotate, the first spring abutment portion 51c compresses the first damper spring 49 between itself and the second spring abutment portion 55b, and power is transmitted from the first damper spring 49 to the output hub 29 via the spring holder 42 connected to the second spring abutment portion 55b. That is, torque is transmitted mechanically between the clutch piston 43 and the output hub 29 via the torque transmission path 46, the torque transmission path 46 being formed from the clutch piston 43, the retainer 51, the first damper spring 49, and the spring holder 42.

A dynamic damper mechanism 64 is attached to the torque transmission path 46, this dynamic damper mechanism 64 being formed by disposing a plurality of, for example six, second damper springs 53 between the inertial rotating body 65 and the first and second retaining plates 54 and 55, which are rotation-transmitting members forming part of the torque transmission path 46, that is, the spring holder 42.

At least part (part in this embodiment) of the inertial rotating body 65 is formed from a disk-shaped inertia plate 41 sandwiched between the first and second retaining plates 54 and 55 forming the spring holder 42 and having its inner peripheral part rotatably supported on the output hub 29, and a weight-adding member 66 fixed to the outer periphery of the inertia plate 41.

A cylindrical collar 57 is disposed between the first and second retaining plates 54 and 55, the cylindrical collar 57 being inserted through an elongated hole 58 provided at a plurality of, for example six, locations spaced at equal intervals in the peripheral direction of the inertia plate 41, and the first and second retaining plates 54 and 55 are linked by means of the second rivets 56, which extends through the collars 57. That is, the inertia plate 41 can rotate relative to the spring holder 42 in only the restricted range through which the collar 57 moves within the elongated hole 58.

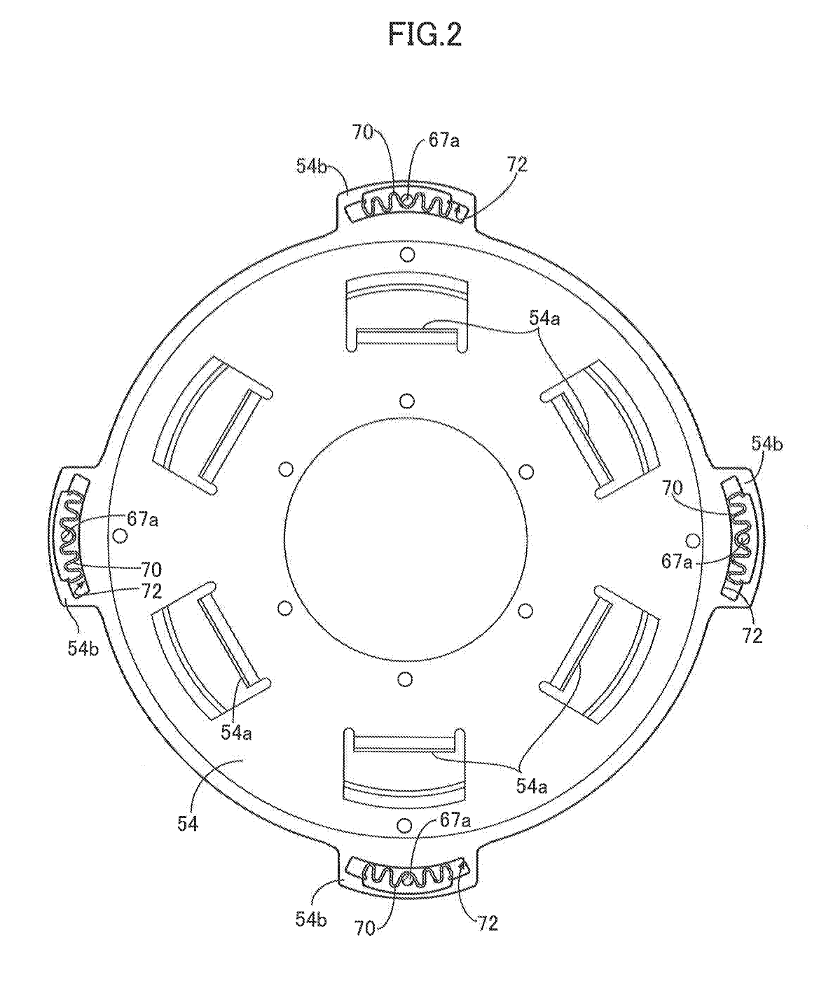

Referring in addition to FIG. 2, spring-retaining portions 54a for retaining the second damper springs 53 are formed at a plurality of, for example six, locations spaced at equal intervals in the peripheral direction of the first retaining plate 54 so that part of the second damper spring 53 is exposed to the outside. Furthermore, a spring-retaining portion 55a for retaining the second damper spring 53 is formed in a portion, corresponding to the spring-retaining portion 54a of the first retaining plate 54, of the second retaining plate 55 so that part of the second damper spring 53 is exposed to the outside.

A spring housing hole 60 housing part of the second spring 53 is formed in portions, corresponding to the spring-retaining portions 54a and 55a, of the inertia plate 41 so that in the disconnected state of the lockup clutch 40 opposite end parts of the spring housing hole 60 along the peripheral direction of the inertia plate 41 abut against opposite end parts of the second damper spring 53.

The inertia plate 41 is formed so that its outer peripheral part projects further radially outward than the first and second retaining plates 54 and 55 forming the spring holder 42, and the weight-adding member 66 is fixed to an outer peripheral part of the inertia plate 41.

The weight-adding member 66 is formed with a substantially L-shaped cross-section while integrally having a ring plate portion 66a opposing an outer peripheral part of the first retaining plate 54 from the turbine runner 12 side across a gap and a tubular portion 66b extending from the outer periphery of the ring plate portion 66a toward the outer peripheral part side of the inertia plate 41, and is fixed to the outer peripheral part of the inertia plate 41 by means of a plurality of fourth rivets 67 having a large diameter portion 67a disposed between the ring plate portion 66a and the inertia plate 41 so that the tubular portion 66b abuts against the inertia plate 41.

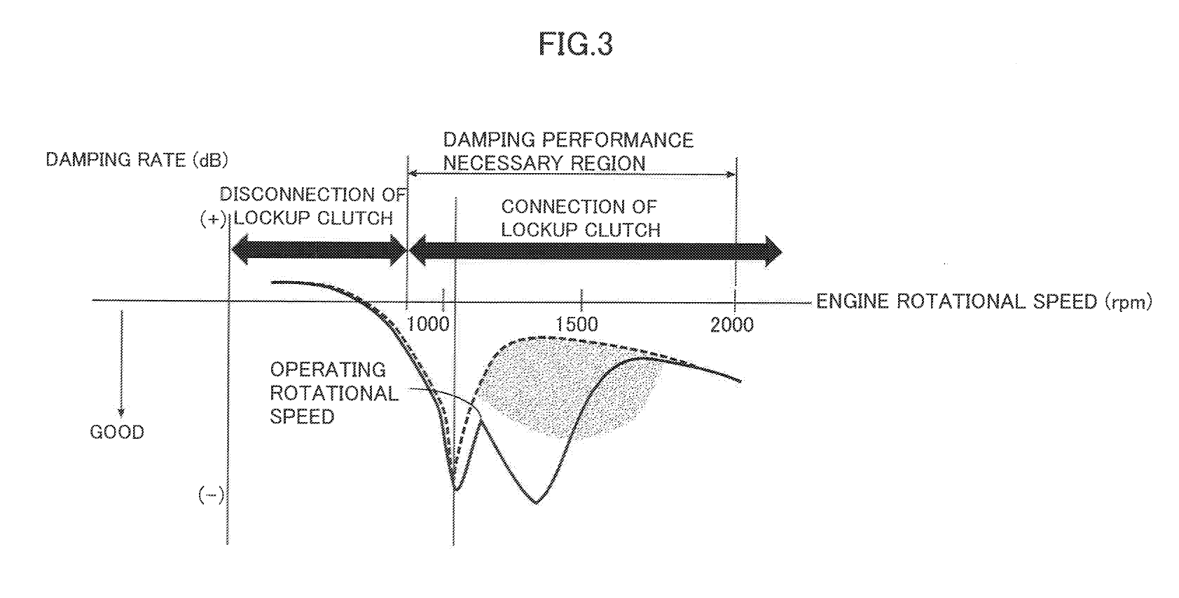

When the vehicle is traveled at a low engine rotational speed in order to reduce the fuel consumption of the vehicular engine E, there are problems with the suppression of muffled sound, vibration, etc. due to torque variation of the vehicular engine E. Such problems are intended to be solved by the dynamic damper mechanism 64, but the damping rate of the dynamic damper mechanism 64 is determined uniquely, and as shown by the broken line in FIG. 3 the operating rotational speed of the dynamic damper mechanism 64 is usually set on the slowest rotational speed side (800 to 1500 rpm) in the connected region of the lockup clutch 40. By so doing, the engine rotational speed region that can give a large damping effect is limited, and as shown by dots in FIG. 3 a region in which a sufficient damping effect cannot be obtained sometimes occurs.

Obtaining a damping effect over a wide rotational speed region as shown by the solid line in FIG. 3 by changing the spring rate of the dynamic damper mechanism 64 according to the engine rotational speed could therefore be considered, and in accordance with the present invention an elastic member 70 that, while being capable of deforming when subjected to a centrifugal force, always links to either one of the inertial rotating body 65 and the first retaining plate 54 of the spring holder 42 of the dynamic damper mechanism 64 is added to the dynamic damper mechanism 64.

In this embodiment, the elastic member 70 is always linked to the inertial rotating body 65 via the fourth rivet 67, and this elastic member 70 is disposed between the first retaining plate 54 and the inertial rotating body 65 while being disposed within the inertial rotating body 65 so that at a time of low speed rotation when the second damper spring 53 can absorb the torque variation no resilient force is exhibited between the elastic member 70 and the first retaining plate 54 but a resilient force is exhibited between the first retaining plate 54 and the inertial rotating body 65 in response to a deformation due to centrifugal force at a time of high speed rotation that is a predetermined rotational speed or greater.

Projecting portions 54b projecting in a radially outward direction are formed integrally with a plurality of, for example four, locations spaced at equal intervals in the peripheral direction on the outer periphery of the first retaining plate 54 so as to project into an annular recess 71 formed between the inertia plate 41 and the weight-adding member 66, and the elastic member 70 enables a resilient force to be exhibited between the projecting portion 54b of the first retaining plate 54 and the inertial rotating body 65.

The elastic member 70 is formed into a wave shape by bending a plate spring so that it extends in the peripheral direction around the rotational axis of the dynamic damper mechanism 64, and the large diameter portion 67a of the fourth rivet 67 of the inertial rotating body 65 is always linked to a middle part, along the peripheral direction, of the elastic member 70 in its natural state.

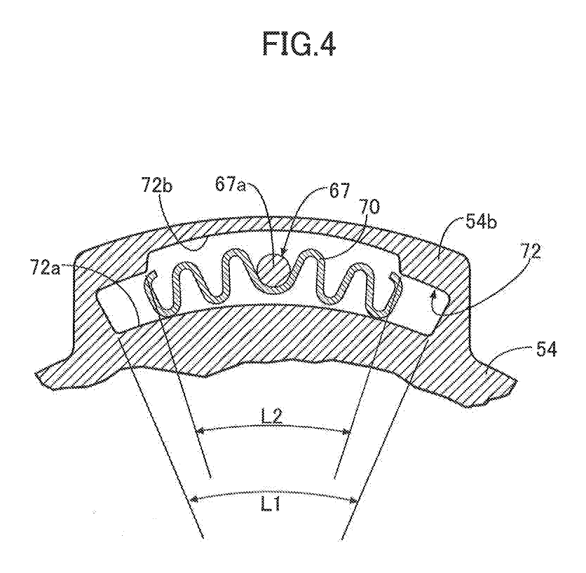

Referring in addition to FIG. 4, formed in the projecting portion 54b as a through hole that opens on opposite faces of the projecting portion 54b is a housing part 72 housing at least part (part in this embodiment) of the elastic member 70. The housing part 72 is formed from an inner housing portion 72a and an outer housing portion 72b connected to the inner housing portion 72a from the outside along the radial direction with the rotational axis of the dynamic damper mechanism 64 as the center. As is clearly shown in FIG. 4 a length L1 along the peripheral direction of the inner housing portion 72a is set so as to be longer in the peripheral direction than the elastic member 70 in its natural state so as to avoid contact of opposite end parts along the peripheral direction of the inner housing portion 72a with opposite end parts along the peripheral direction of the elastic member 70 at a time of low speed rotation of the vehicular engine E.

Furthermore, a length L2 along the peripheral direction of the outer housing portion 72b is set so as to be shorter in the peripheral direction than the inner housing portion 72a so that opposite end parts along the peripheral direction of the outer housing portion 72b make contact with opposite end parts along the peripheral direction of the elastic member 70 that has been deformed by being subjected to centrifugal force at a time of high speed rotation of the vehicular engine E.

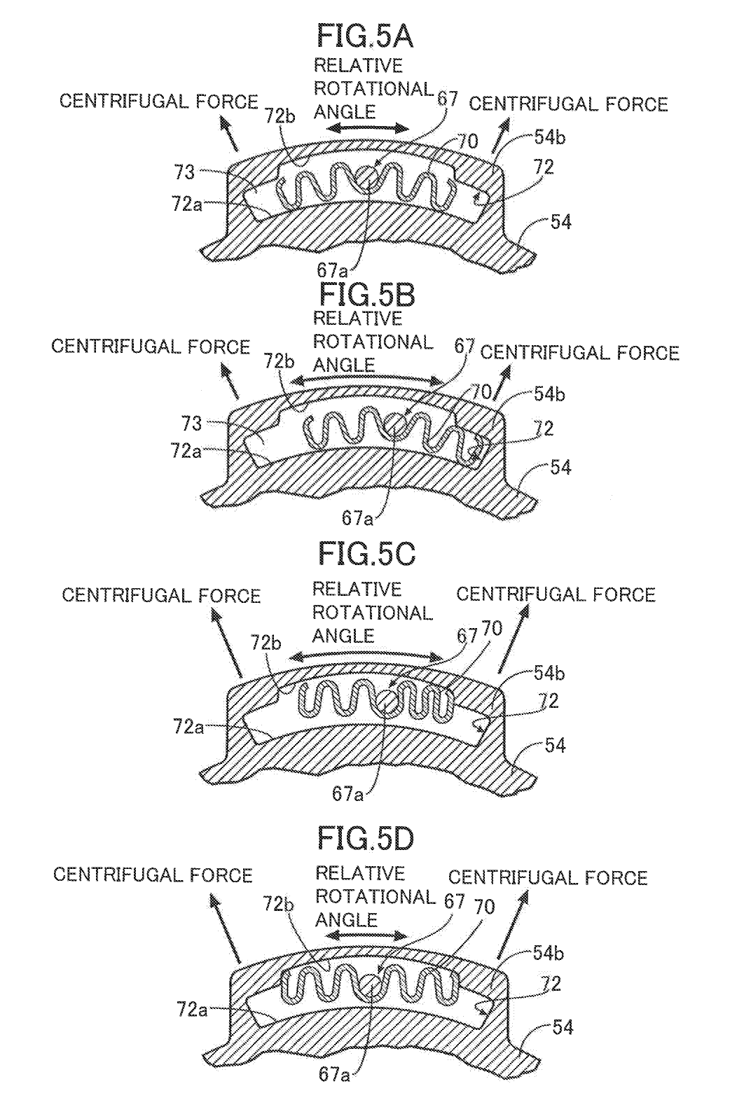

Such behavior of the elastic member 70 is explained by reference to FIG. 5. In a state in which the rotational speed of the vehicular engine E is low, the relative rotational angle between the first retaining plate 54 and the inertial rotating body 65 is small, and the centrifugal force acting on the elastic member 70 is small; as shown in FIG. 5A, the elastic member 70 is at a position corresponding to the inner housing portion 72a of the housing part 72, play 73 in the torque direction occurs between the first retaining plate 54 and the elastic member 70, and the elastic member 70 is in a non-operational state between the first retaining plate 54 and the inertial rotating body 65.

In a state in which the centrifugal force acting on the elastic member 70 is still small even though the rotational speed of the vehicular engine E has increased and the relative rotational angle between the first retaining plate 54 and the inertial rotating body 65 is large, as shown in FIG. 5B the elastic member 70 is at a position corresponding to the inner housing portion 72a of the housing part 72, the play 73 in the torque direction between the first retaining plate 54 and the elastic member 70 remains, and the elastic member 70 is in the non-operational state between the first retaining plate 54 and the inertial rotating body 65.

When the relative rotational angle between the first retaining plate 54 and the inertial rotating body 65 increases and the centrifugal force acting on the elastic member 70 increases as the rotational speed of the vehicular engine E increases, as shown in FIG. 5C the elastic member 70 deforms so that its opposite end parts enter the outer housing portion 72b of the housing part 72, and the elastic member 70 operates so that a resilient force is exhibited between the first retaining plate 54 and the inertial rotating body 65. That is, the spring force of the elastic member 70 is applied to the dynamic damper mechanism 64, and the resonant frequency of the dynamic damper mechanism 64 shifts to the high rotation side. As a result, as shown by the solid line in FIG. 3 the frequency characteristics change to the side on which the damping rate becomes high at an operating rotational speed at which the elastic member 70 starts operating, and the damping range increases.

In a state in which the centrifugal force acting on the elastic member 70 has increased in response to an increase in the rotational speed of the vehicular engine E, as shown in FIG. 5D the opposite end parts of the elastic member 70 abut against the projecting portion 54b of the first retaining plate 54 in a state in which the elastic member 70 is housed in the outer housing portion 72b of the housing part 72, but due to the characteristic of the dynamic damper mechanism 64 that the relative rotational angle decreases on the side where the rotational speed is higher than the resonant frequency, the relative rotational angle between the first retaining plate 54 and the inertial rotating body 65 becomes small, and the elastic member 70 is not subjected to a load that is larger than necessary.

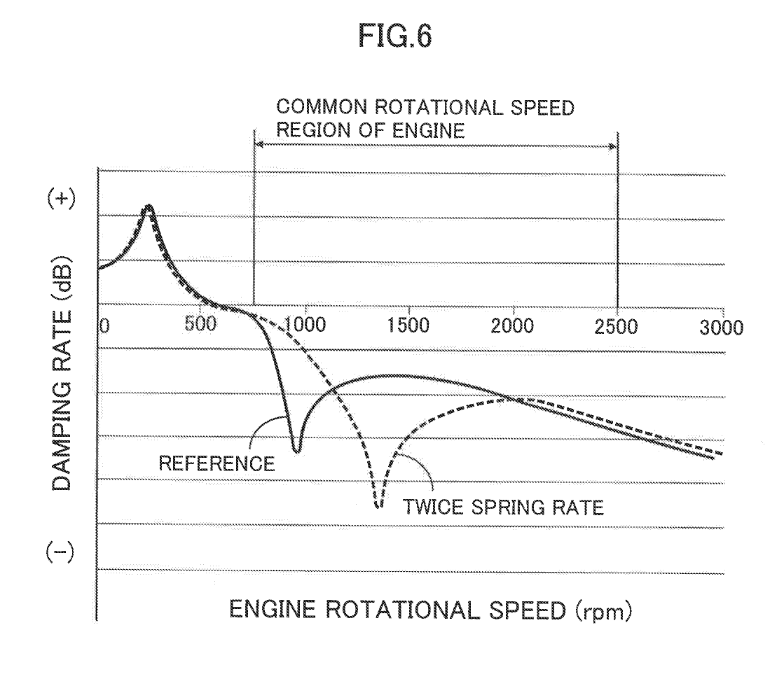

When the damping rate of the dynamic damper mechanism 64 disposed in the torque transmission path 46 of the torque converter provided between the transmission and the crankshaft 23 of the vehicular engine E whose common rotational speed range is 800 to 2500 rpm is calculated using a usual vehicle vibration model as a reference, the results shown in FIG. 6 are obtained. When the result obtained by calculation with a resonant frequency of 1000 rpm is shown by the solid line in FIG. 6, the result obtained when the spring rate of the dynamic damper mechanism 64 is twice the reference example where the resonant frequency is 1000 rpm is shown by the broken line in FIG. 6.

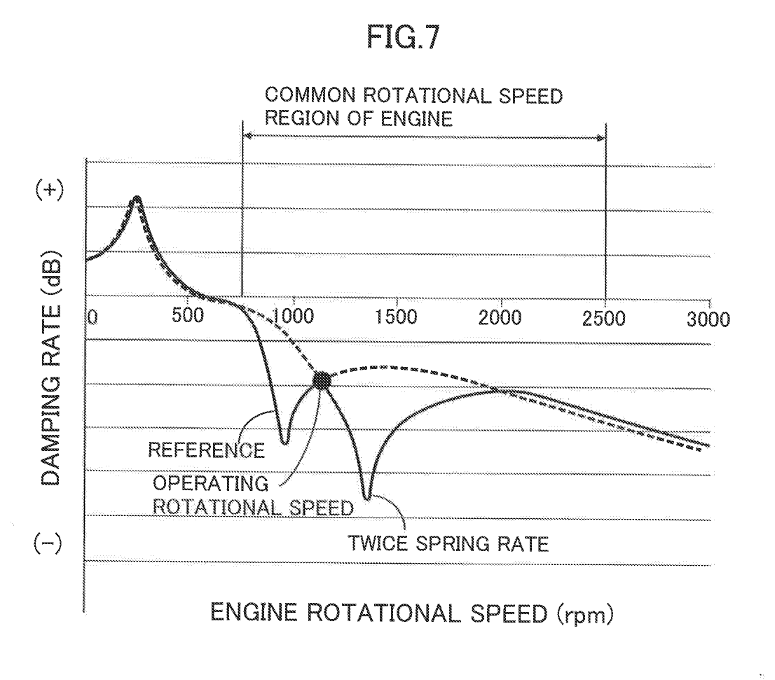

When, with the frequency characteristics of the spring rate at a time of low speed rotation as the reference example, the spring rate at a time of high rotational speed where the added elastic member 70 operates is set to twice that at a time of low rotational speed, the dynamic damper mechanism 64 to which the elastic member 70 is added can give the frequency characteristics shown by the solid line in FIG. 7. That is, it follows the frequency characteristics of the reference example before the elastic member 70 operates, and it follows the frequency characteristics where the spring rate is double in the high rotational speed region in which the added elastic member 70 operates. Here, the most advantageous method for setting the operating rotational speed of the elastic member 70 is an intersection point present between the resonance points of one dynamic damper; when the operating rotational speed is set in that way, the resonance points of the dynamic damper are present on opposite sides of the operating rotational speed, and a more advantageous operating rotational speed range is 800 to 2000 rpm, which is close to the common rotational speed region of the vehicular engine E.

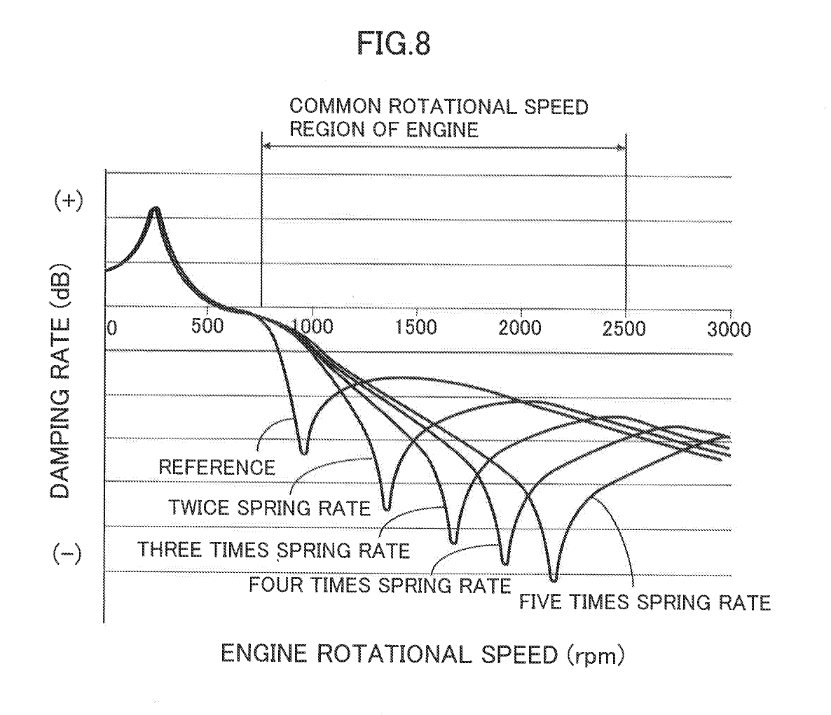

The frequency characteristics when, with the frequency characteristics of the spring rate at a time of low speed rotation as a reference example, the spring rate at a time of high rotational speed where the added elastic member 70 operates is set to twice, three times, four times, and five times that at a time of low rotational speed changes as shown in FIG. 8, and the resonant frequency of the dynamic damper is shifted to the high speed side by setting the spring rate high, but since low frequency vibration excited in a low speed rotation region is easily perceived, and an abnormal noise due to the vibration tends to be easily heard, it is desirable to set the spring rate at a value corresponding to the low speed rotation region (800 to 1500 rpm), thus suppressing the occurrence of low frequency vibration in the low speed rotation region (800 to 1500 rpm).

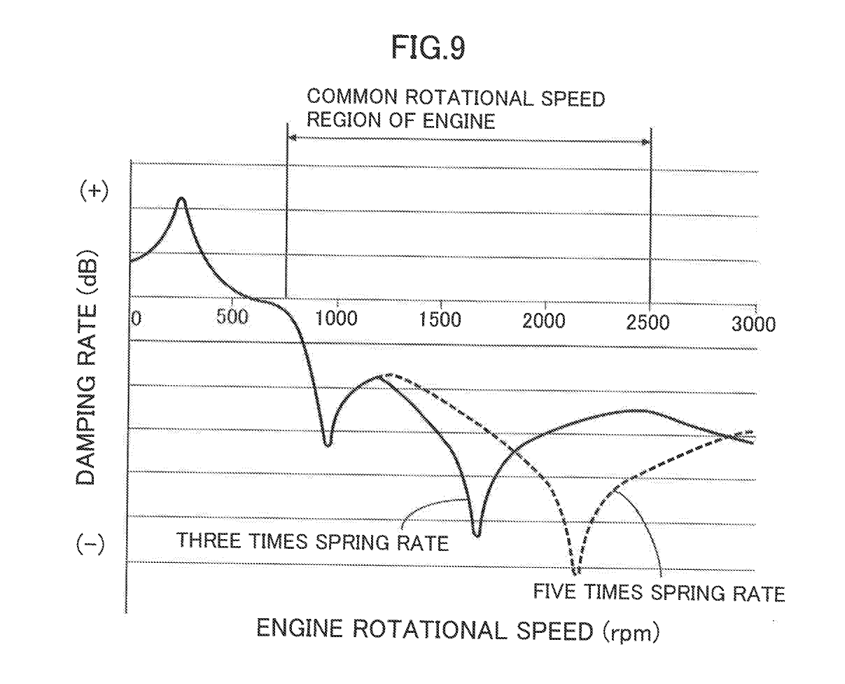

When the resonant frequency of the dynamic damper in the low speed rotation region is set at 1000 rpm as in the reference example of FIG. 8, in order to improve the damping performance over a wider range of a range of 800 to 2500 rpm, which is the common rotational speed region of the vehicular engine E, it is desirable to set the spring rate of the high rotational speed region due to operation of the elastic member 70 to at least three times, and the frequency characteristics shown by the solid line in FIG. 9 are obtained when the spring rate is three times. In addition, when the spring rate of the high rotational speed region is set to five times that of the low rotational speed region, the frequency characteristics become those shown by the dotted line in FIG. 9, and the damping performance around the rotational speed (around 1200 to 1700 in FIG. 9) where the added elastic member 70 starts operating becomes insufficient; taking this into consideration it is desirable to set the spring rate of the dynamic damper mechanism 64 having the elastic member 70 so that the ratio of that at a time of high speed rotation relative to that at a time of low speed rotation is greater than 1 but no greater than 4.

The operation of this first embodiment is now explained. The torque transmission path 46 for transmitting the torque from the vehicular engine E is provided with the dynamic damper mechanism 65 formed by disposing the plurality of second damper springs 53 between the inertial rotating body 65 and the spring holder 42 formed from the first and second retaining plates 54 and 55 forming part of the torque transmission path 46. The elastic member 70 which, while being capable of deforming when subjected to a centrifugal force, is always linked to the inertial rotating body 65, which is either one of the spring holder 42 and the inertial rotating body 65, is added to the dynamic damper mechanism 64. The elastic member 70 is disposed between the spring holder 42 and the inertial rotating body 65 so that the play 73 in the torque direction occurs between itself and the spring holder 42, which is the other one of the spring holder 42 and the inertial rotating body 65, at a time of low speed rotation when torque variation can be absorbed by the second damper spring 53, but a resilient force is exhibited between the spring holder 42 and the inertial rotating body 65 in response to deformation due to centrifugal force at a time of high speed rotation that is a predetermined rotational speed or greater.

Therefore, in the dynamic damper mechanism 64, the spring force of the elastic member 70 is applied to the second damper spring 53 at a time of high speed rotation, the resonant frequency of the dynamic damper mechanism 64 shifts toward the high speed rotation side, the spring rate of the dynamic damper mechanism 64 can be changed according to the rotational speed, and in order to realize this only the elastic member 70 is added, thus enabling a simple structure in which any increase in the number of components is suppressed to be achieved.

Furthermore, since the spring rate of the dynamic damper mechanism 64 having the elastic member 70 is set so that the ratio of that at the time of high speed rotation relative to that at the time of low speed rotation is greater than 1 but no greater than 4, the damping performance can be enhanced over a wide range of the common rotational speed region of the vehicular engine E. That is, since low frequency vibration excited in a low speed rotation region is easily perceived, and an abnormal noise due to the vibration tends to be easily heard, it is possible, by setting the spring rate at a value corresponding to the low speed rotation region, to obtain an effective damping performance over a wide range of the common rotational speed region of the vehicular engine E while suppressing the occurrence of low frequency vibration in the low speed rotation region.

Furthermore, since the elastic member 70 is disposed within the inertial rotating body 65, it is possible to avoid any increase in the dimensions of the dynamic damper mechanism 64 due to addition of the elastic member 70.

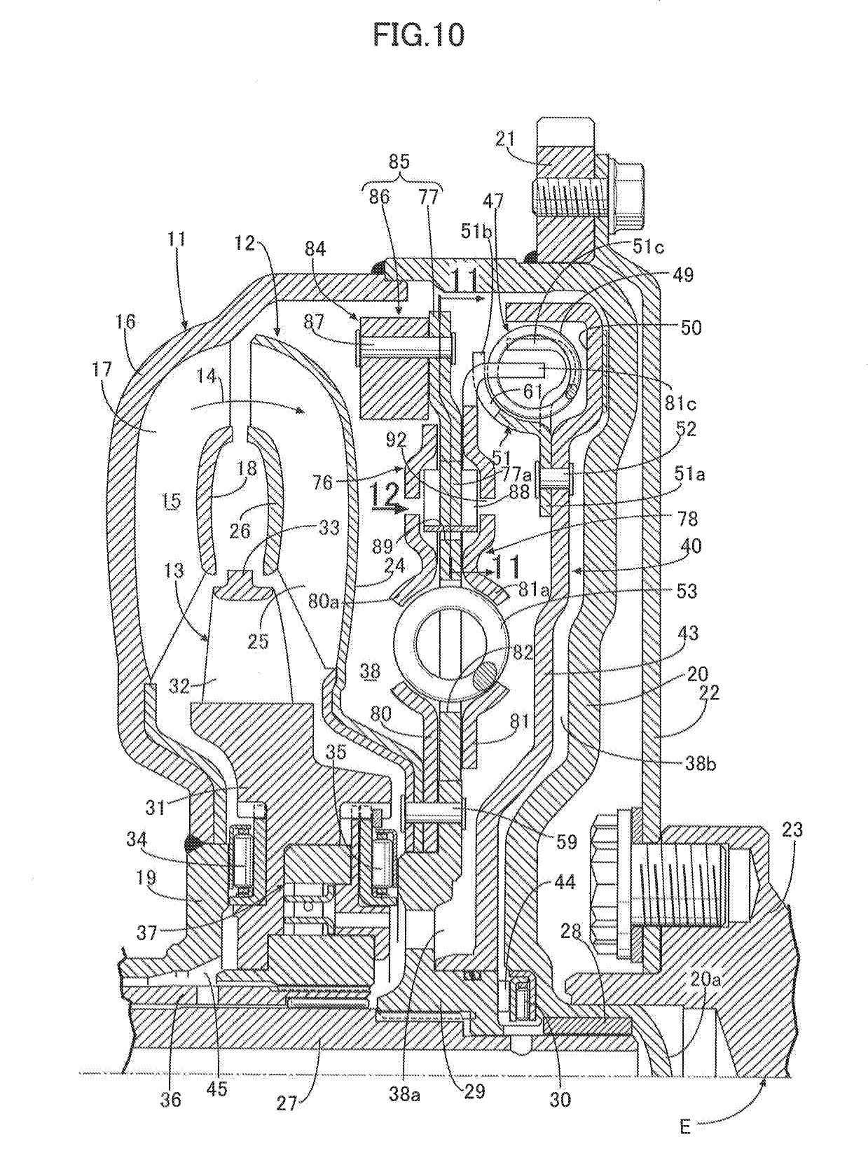

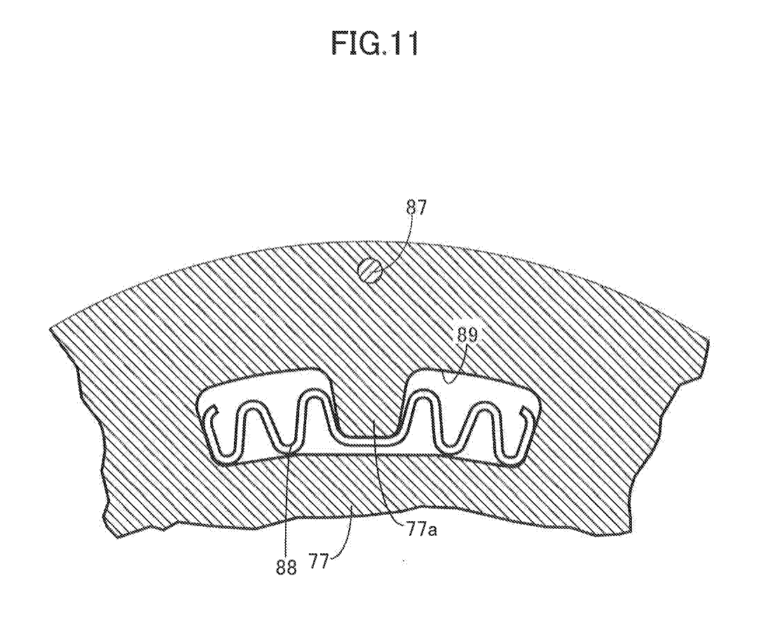

A second embodiment of the present invention is explained by reference to FIG. 10 to FIG. 12B; parts corresponding to those of the first embodiment shown in FIG. 1 to FIG. 9 are denoted by the same reference numerals and symbols, and detailed explanation thereof is omitted.

When the lockup clutch 40 attains a connected state, torque that is transmitted from the vehicular engine E to the transmission cover 20 is transmitted mechanically to the output hub 29 via a torque transmission path 78 that includes the clutch piston 43 and a spring holder 76, the damper mechanism 47 being disposed in the torque transmission path 78.

The damper mechanism 47 is formed by disposing the plurality of, for example four, first damper springs 49 spaced at equal intervals in the peripheral direction between the spring holder 76 and the clutch piston 43, which can rotate relative to each other around the rotational axis.

The spring holder 76 is formed from first and second retaining plates 80 and 81, which are rotation-transmitting members forming part of the torque transmission path 78; the first retaining plate 80 is fixed to the output hub 29 together with an inner peripheral part of the turbine shell 24 by means of the plurality of third rivets 59, and the second retaining plate 81 spaced from the first retaining plate 80 in a direction along the axis of the output shaft 27 is relatively non-rotatably linked to the first retaining plate 80 by means of a plurality of rivets, which are not illustrated.

Furthermore, a second spring abutment part 81c is integrally and connectedly provided on the outer periphery at a plurality of, for example four, locations spaced at equal intervals in the peripheral direction of the second retaining plate 81, the second spring abutment part 81c penetrating into the housing recess 50 so as to sandwich the first damper spring 49 between itself and the first spring abutment portion 51c of the retainer 51 fixed to the clutch piston 43. The opening 61 is formed in the spring cover portion 51b of the retainer 51, the second spring abutment part 81c being inserted through the opening 61 so as to allow relative rotation in a restricted range relative to the second spring abutment part 81c, that is, the spring holder 76.

When the lockup clutch 40 attains a connected state and the clutch piston 43 and the retainer 51 rotate, the first spring abutment portion 51c compresses the first damper spring 49 between itself and the second spring abutment part 81c, and power is transmitted from the first damper spring 49 to the output hub 29 via the spring holder 76 connected to the second spring abutment part 81c. That is, torque is transmitted mechanically between the clutch piston 43 and the output hub 29 via the torque transmission path 78, the torque transmission path 78 being formed from the clutch piston 43, the retainer 51, the first damper spring 49, and the spring holder 76.

The torque transmission path 78 is provided with a dynamic damper mechanism 84. This dynamic damper mechanism 84 is formed by disposing a plurality of, for example six, second damper springs 53 between the spring holder 76 and an inertial rotating body 85.

The inertial rotating body 85 is formed from a disk-shaped inertia plate 77 and a weight-adding member 86. At least part (part in this embodiment) of the inertia plate 77 is sandwiched between the first and second retaining plates 80 and 81 forming the spring holder 76, and an inner peripheral part of the inertia plate 77 is rotatably supported on the output hub 29, the weight-adding member 86 being fixed to the outer periphery of the inertia plate 77 by means of a plurality of fifth rivets 87.

A spring-retaining portion 80a for retaining the second damper spring 53 is formed at a plurality of, for example six, locations spaced at equal intervals in the peripheral direction of the first retaining plate 80, part of the second damper spring 53 being exposed to the outside. Furthermore, a spring-retaining portion 81a for retaining the second damper spring 53 is formed in a part, corresponding to the spring-retaining portion 80a of the first retaining plate 80, of the second retaining plate 81 so that part of the second damper spring 53 is exposed to the outside.

Formed in a part, corresponding to the spring-retaining portions 80a and 81a, of the inertia plate 77 is a spring housing hole 82 housing part of the second damper spring 53. In a disconnected state of the lockup clutch 40, opposite end parts of the spring housing hole 82 along the peripheral direction of the inertia plate 77 abut against opposite end parts of the second damper spring 53.

The inertia plate 77 is formed so that its outer peripheral part projects further radially outward than the first and second retaining plates 80 and 81 forming the spring holder 76, and the weight-adding member 86 is fixed to the outer peripheral part of the inertia plate 77.

An elastic member 88 is added to the dynamic damper mechanism 84 so that it is always linked to either one of the first retaining plate 80 and the inertial rotating body 85 of the spring holder 76 of the dynamic damper mechanism 84 and can deform when subjected to a centrifugal force.

The elastic member 88 is always linked to the inertia plate 77 forming part of the inertial rotating body 85, and this elastic member 88 is disposed between the spring holder 76 and the inertial rotating body 85 while being disposed within the spring holder 76 so that a resilient force is not exhibited between itself and the spring holder 76 formed from the first and second retaining plates 80 and 81 at a time of low speed rotation when torque variation can be absorbed by the second damper spring 53 but a resilient force is exhibited between the spring holder 76 and the inertial rotating body 85 in response to deformation due to centrifugal force at a time of high speed rotation that is a predetermined rotational speed or greater.

Spring housing holes 89 that are long along the peripheral direction of the inertia plate 77 are formed at a plurality of locations spaced at equal intervals in the peripheral direction of part of the inertia plate 77 that are positioned further radially outward than the second damper spring 53 and that are positioned further radially inward than a fifth rivet 87 for fixing the weight-adding member 86.

The elastic member 88 is formed into a wave shape by bending a plate spring so as to extend in the peripheral direction around the rotational axis of the dynamic damper mechanism 84, and is housed in the spring housing hole 89 so that opposite end parts of the elastic member 88 in the natural state abut against opposite end parts in the longitudinal direction of the spring housing hole 89. A projecting portion 77a is linked to a middle part along the peripheral direction in the natural state of the elastic member 88, the projecting portion 77a being projectingly provided integrally with the inertia plate 77 so as to project into the spring housing hole 89 from a middle part along the peripheral direction of the spring housing hole 89.

On the other hand, formed as a through hole opening on opposite faces of the retaining plates 80 and 81 in each of the first and second retaining plates 80 and 81 disposed on opposite sides of the inertia plate 77 is a housing part 92 housing part of the elastic member 88. Formed in parts, corresponding to the housing part 92, of the first and second retaining plates 80 and 81 are spring-retaining portions 80b and 81b for retaining the elastic member 88, part of the elastic member 88 facing the outside.

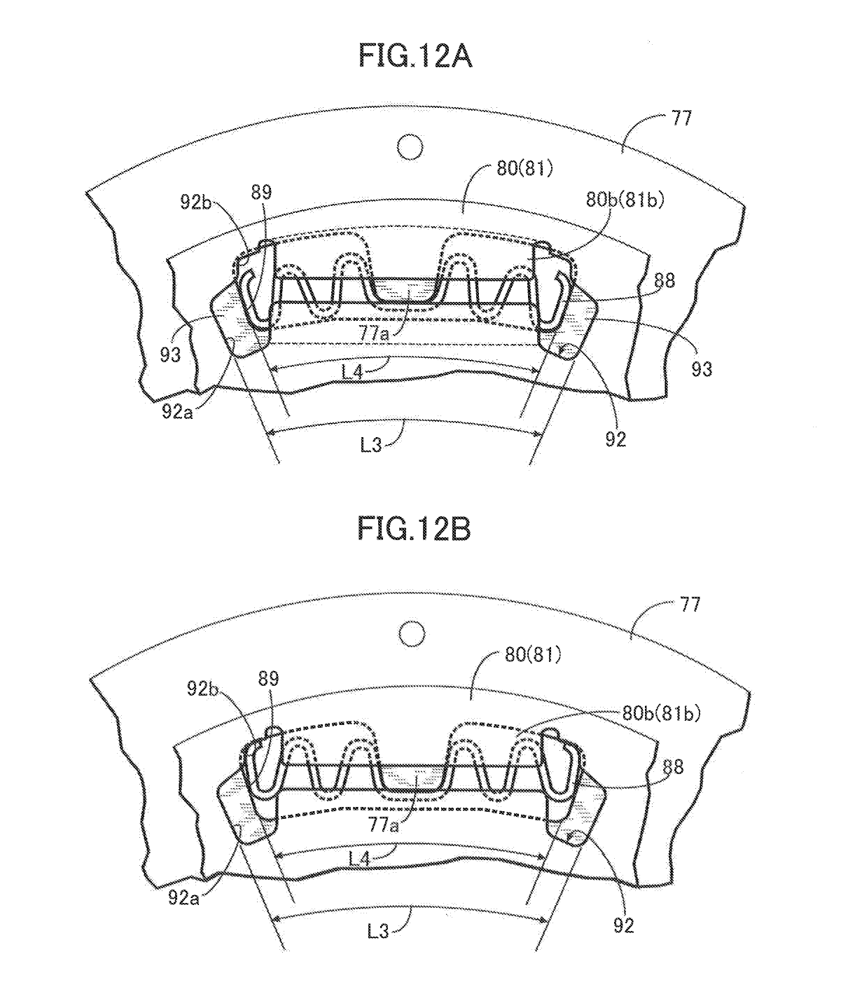

The housing part 92 is formed from an inner housing portion 92a and an outer housing portion 92b connected to the inner housing portion 92a from the outside along the radial direction with the rotational axis of the dynamic damper mechanism 84 as the center. As clearly shown in FIG. 12A a length L3 along the peripheral direction of the inner housing portion 92a is set so as to be longer in the peripheral direction than the elastic member 88 in the natural state so as to avoid contact of opposite end parts along the peripheral direction of the inner housing portion 92a with opposite end parts along the peripheral direction of the elastic member 88 at a time of low speed rotation of the vehicular engine E. Furthermore, a length L4 along the peripheral direction of the outer housing portion 92b is set so as to be shorter in the peripheral direction than the inner housing portion 92a so that opposite end parts along the peripheral direction of the outer housing portion 92b make contact with opposite end parts along the peripheral direction of the elastic member 88 that has been deformed by being subjected to centrifugal force at a time of high speed rotation of the vehicular engine E.

In accordance with the elastic member 88 and the housing part 92, in a state in which the rotational speed of the vehicular engine E is low and the centrifugal force acting on the elastic member 88 is small, as shown in FIG. 12A, the elastic member 88 is present at a position corresponding to the inner housing portion 92a of the housing part 92, play 93 in the torque direction occurs between the first and second retaining plates 80 and 81 and the elastic member 88, and the elastic member 88 is in a non-operational state between the first and second retaining plates 80 and 81 and the inertial rotating body 85.

When the rotational speed of the vehicular engine E increases and the centrifugal force acting on the elastic member 88 increases, as shown in FIG. 12B, the elastic member 88 deforms so that its opposite end parts enter the outer housing portion 92b of the housing part 92, and the elastic member 88 operates so that a resilient force is exhibited between the first and second retaining plates 80 and 81 and the elastic member 88. That is, the spring force of the elastic member 88 is applied to the dynamic damper mechanism 84.

Moreover, it is desirable that the spring rate at a time of high speed rotation of the dynamic damper mechanism 84 having the elastic member 88 is set so that the ratio of that at a time of high speed rotation relative to that at a time of low speed rotation is greater than 1 but no greater than 4 as in the first embodiment.

In accordance with this second embodiment, the same effects as those of the first embodiment described above can be exhibited and, moreover, since the elastic member 88 is disposed within the spring holder 76, it is possible to avoid any increase in the dimensions of dynamic damper mechanism 84 due to the addition of the elastic member 88.

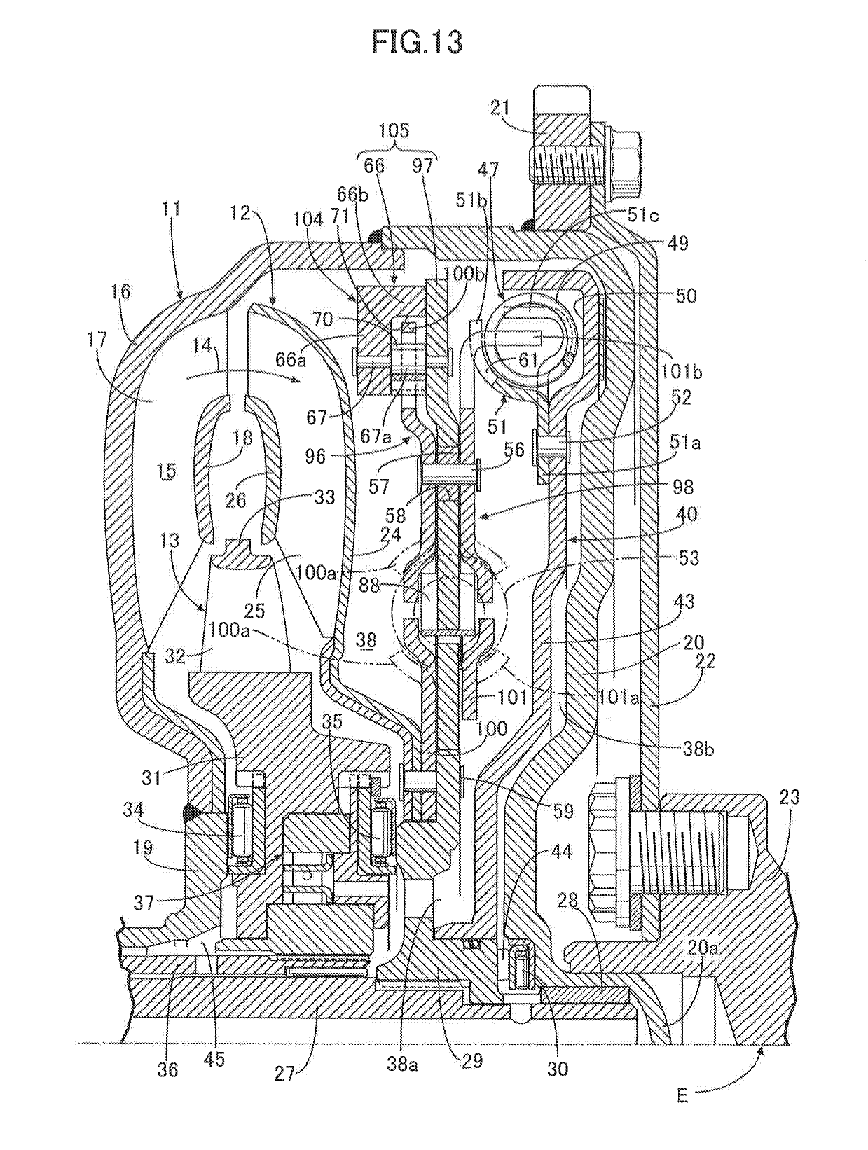

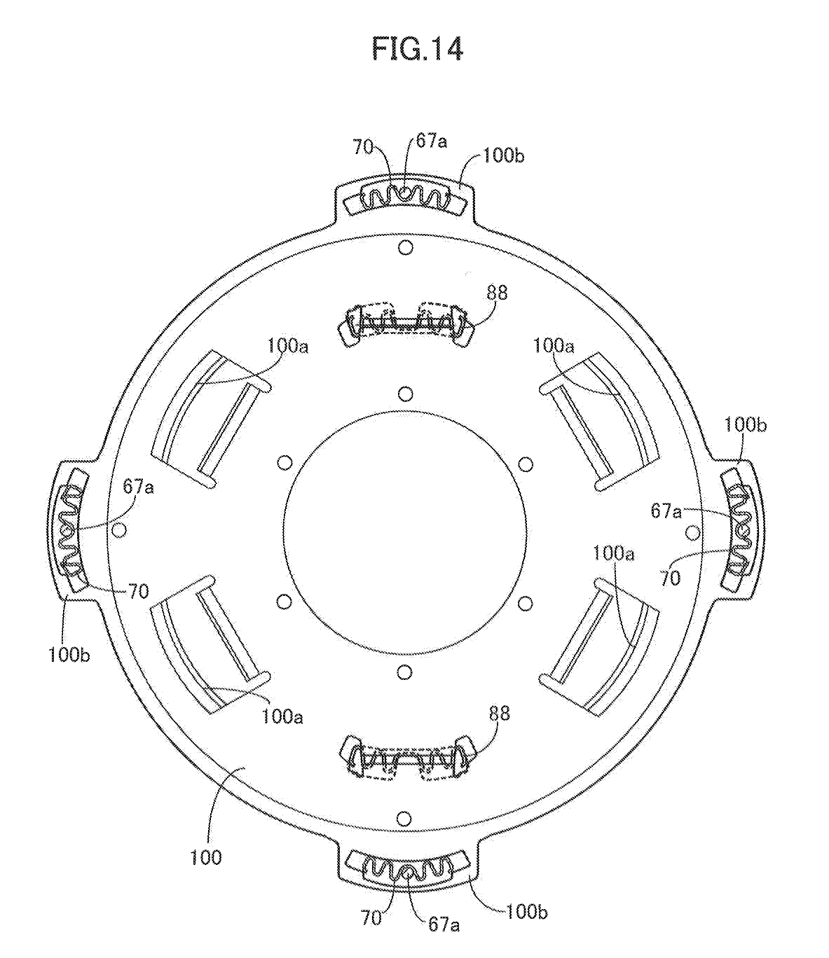

A third embodiment of the present invention is explained by reference to FIG. 13 to FIG. 15; parts corresponding to those of the first embodiment shown in FIG. 1 to FIG. 9 and those of the second embodiment shown in FIG. 10 to FIG. 12B are denoted by the same reference numerals and symbols, and detailed explanation thereof is omitted.

When the lockup clutch 40 attains a connected state, torque transmitted from the vehicular engine E to the transmission cover 20 is transmitted mechanically to the output hub 29 via a torque transmission path 98 that includes the clutch piston 43 and a spring holder 96, this torque transmission path 98 having the damper mechanism 47 disposed therein.

The damper mechanism 47 is formed by disposing the plurality of, for example four, first damper springs 49 spaced at equal intervals in the peripheral direction between the clutch piston 43 and the spring holder 96, which can rotate relative to each other around the rotational axis.

The spring holder 96 is formed from first and second retaining plates 100 and 101, which are rotation-transmitting members forming part of the torque transmission path 98; the first retaining plate 100 is fixed to the output hub 29 together with an inner peripheral part of the turbine shell 24 by means of the plurality of third rivets 59, and the second retaining plate 101, which is spaced from the first retaining plate 100 in a direction along the axis of the output shaft 27, is relatively non-rotatably linked to the first retaining plate 100 by means of the plurality of second rivets 56.

A second spring abutment part 101b is integrally and connectedly provided with the outer periphery at a plurality of, for example four, locations spaced at equal intervals in the peripheral direction of the second retaining plate 101, the second spring abutment part 101b penetrating into the housing recess 50 so as to sandwich the first damper spring 49 between itself and the first spring abutment portion 51c of the retainer 51 fixed to the clutch piston 43, and the opening 61 is formed in the spring cover portion 51b of the retainer 51 so as to allow relative rotation in a limited range between the spring cover portion 51b and the second spring abutment part 101b, that is, the spring holder 96, the second spring abutment part 101b being inserted through the opening 61.

When the lockup clutch 40 attains a connected state and the clutch piston 43 and the retainer 51 rotate, the first spring abutment portion 51c compresses the first damper spring 49 between itself and the second spring abutment part 101b, and power is transmitted from the first damper spring 49 to the output hub 29 via the spring holder 96 connected to the second spring abutment part 101b. That is, torque is transmitted mechanically between the clutch piston 43 and the output hub 29 via the torque transmission path 98, the torque transmission path 98 being formed from the clutch piston 43, the retainer 51, the first damper spring 49, and the spring holder 96.

Attached to the torque transmission path 98 is a dynamic damper mechanism 104. This dynamic damper mechanism 104 is formed by disposing the plurality of, for example four, second damper springs 53 between an inertial rotating body 105 and the first and second retaining plates 100 and 101, which are rotation-transmitting members forming part of the torque transmission path 98, that is, the spring holder 96.

The inertial rotating body 105 is formed from an inertia plate 97 and the weight-adding member 66 fixed to the outer periphery of the inertia plate 97, the inertia plate 97 having at least part thereof (part in this embodiment) sandwiched between the first and second retaining plates 100 and 101 forming the spring holder 96 and having its inner peripheral part rotatably supported on the output hub 29.

The cylindrical collar 57 is disposed between the first and second retaining plates 100 and 101, the cylindrical collar 57 being inserted through the elongated hole 58 provided at a plurality of, for example six, locations spaced at equal intervals in the peripheral direction of the inertia plate 97. That is, the spring holder 96 can rotate relative to the inertia plate 97 only in a limited range via which the collar 57 moves within the elongated hole 58.

Formed at a plurality of, for example four, locations spaced at equal intervals in the peripheral direction of the first retaining plate 100 are spring-retaining portions 100a for retaining the second damper spring 53, part of the second damper spring 53 being exposed to the outside. Furthermore, formed in a part, corresponding to the spring-retaining portion 100a of the first retaining plate 100, of the second retaining plate 101 is a spring-retaining portion 101a for retaining the second damper spring 53, part of the second damper spring 53 being exposed to the outside.

The inertia plate 97 is formed so that its outer peripheral part projects further radially outward than the first and second retaining plates 100 and 101 forming the spring holder 96, and the weight-adding member 66 is fixed to an outer peripheral part of the inertia plate 97.

Formed in a part, corresponding to the spring-retaining portions 100a and 101a, of the inertia plate 97 is a spring housing hole (not illustrated) housing part of the second spring 53, this spring housing hole being formed so that opposite end parts of the spring housing hole along the peripheral direction of the inertia plate 97 abut against opposite end parts of the second damper spring 53 in a disconnected state of the lockup clutch 40.

At least two types of elastic members are added to the dynamic damper mechanism 104 so that the spring rate of the dynamic damper mechanism 104 can be changed between at least two different rotational speeds. In this third embodiment, the elastic member 70 and the elastic member 88 are added to the dynamic damper mechanism 104.

The elastic member 70 is always linked to the inertia body 105 via the fourth rivet 67 as in the first embodiment, and is disposed between the first retaining plate 100 and the inertial rotating body 105 while being disposed within the inertial rotating body 105.

Furthermore, the elastic member 88 is, as in the second embodiment, always linked to the inertia plate 97 forming part of the elastic rotating body 105, and is disposed between the spring holder 96 and the inertial rotating body 105 while being disposed within the spring holder 96.

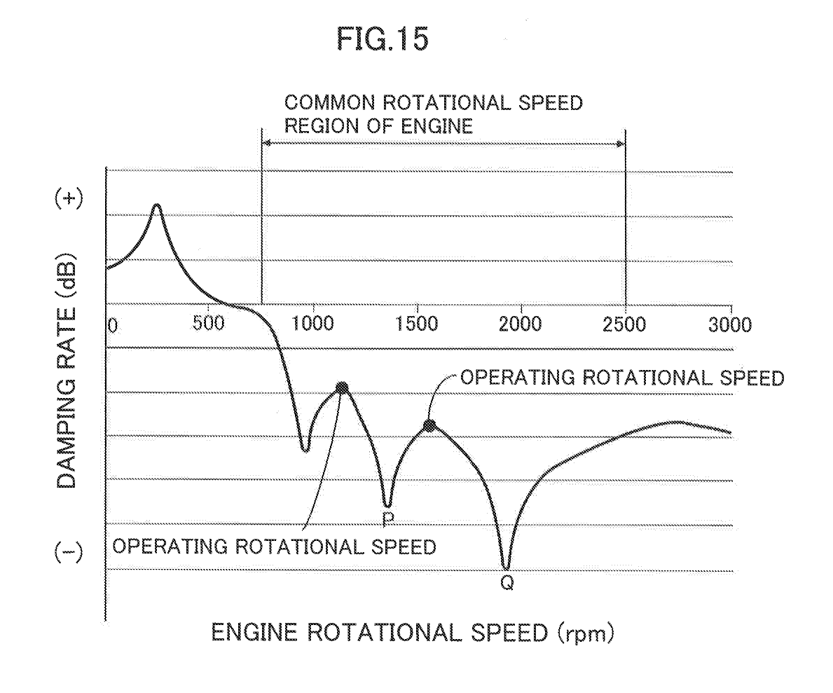

As described above, due to the elastic members 70 and 88 being added, the dynamic damper mechanism 104 exhibits the frequency characteristics shown in FIG. 15. That is, when one of the elastic members 70 and 88 operates and exhibits a spring rate that is twice that at a time of low speed rotation, operating at an operating rotational speed of for example 1100 rpm creates a dynamic damper resonance point P around for example 1350 rpm, and when the other of the elastic members 70 and 88 operates and exhibits a spring rate that is four times that at a time of low speed rotation, operating at an operating rotational speed of for example 1500 rpm creates a dynamic damper resonance point Q around for example 1900 rpm.

In accordance with this third embodiment, in addition to the effects of the first and second embodiments described above, since the two types of elastic members 70 and 88 are added to the dynamic damper mechanism 104, and the spring rate of the dynamic damper mechanism 104 is changed for two different rotational speeds by means of these elastic members 70 and 88, it is possible to obtain more effective damping performance in a driving rotational region of the vehicular engine E.

Embodiments of the present invention are explained above, but the present invention is not limited to the above-mentioned embodiments and may be modified in a variety of ways as long as the modifications do not depart from the gist of the present invention.

What is claimed is:

1. A fluid type power transmission device in which a torque transmission path for transmitting torque from a vehicular engine is provided with a dynamic damper mechanism formed by disposing a plurality of damper springs between an inertial rotating body and a rotation-transmitting member forming part of the torque transmission path, wherein an elastic member that, while being capable of deforming when subjected to a centrifugal force, is always linked to either one of the rotation-transmitting member and the inertial rotating body is added to the dynamic damper mechanism, and the elastic member is disposed between the rotation-transmitting member and the inertial rotating body so that play occurs in a torque direction between the elastic member and the other one of the rotation-transmitting member and the inertial rotating body at a time of low speed rotation where torque variation can be absorbed by the damper spring but so that a resilient force is exhibited between the rotation-transmitting member and the inertial rotating body in response to deformation due to centrifugal force at a time of high speed rotation that is a predetermined rotational speed or greater.

2. The fluid type power transmission device according to claim 1, wherein a spring rate of the dynamic damper mechanism having the elastic member is set so that a ratio of the spring rate at the time of high speed rotation relative to the spring rate at the time of low speed rotation is greater than 1 but no greater than 4.

3. The fluid type power transmission device according to claim 1, wherein at least two types of elastic members, as said elastic member, are added to the dynamic damper mechanism so that the spring rate of the dynamic damper mechanism is changed for at least two different rotational speeds.

4. The fluid type power transmission device according to claim 2, wherein at least two types of elastic members, as said elastic member, are added to the dynamic damper mechanism so that the spring rate of the dynamic damper mechanism is changed for at least two different rotational speeds.

5. The fluid type power transmission device according to claim 1, wherein the elastic member is disposed within the inertial rotating body.

6. The fluid type power transmission device according to claim 1, wherein a pair of rotation-transmitting members, as said rotation-transmitting member, sandwiching at least part of the inertial rotating body from opposite sides are relatively non-rotatably linked so as to form a spring holder holding the damper spring disposed between the rotation-trasmitting members and the inertial rotating body, and the elastic member is disposed within the spring holder.

7. The fluid type power transmission device according to claim 1, wherein the elastic member is formed by bending a plate spring.

8. The fluid type power transmission device according to claim 1, wherein either one of the rotation-transmitting member and the inertial rotating body is always linked to a middle part of the elastic member along a peripheral direction around a rotational axis of the dynamic damper mechanism in a natural state of the elastic member, the elastic member extending in the peripheral direction around the rotational axis, a housing part housing at least part of the elastic member is formed on the other one of the rotation-transmitting member and the inertial rotating body, the housing part is formed from an inner housing portion and an outer housing portion connected to the inner housing portion from an outside along a radial direction with the rotational axis as a center, a length along the peripheral direction of the inner housing portion is set so as to be longer in the peripheral direction than the elastic member in the natural state so as to avoid contact of opposite end parts along the peripheral direction of the inner housing portion with opposite end parts along the peripheral direction of the elastic member at the time of low speed rotation, and a length along the peripheral direction of the outer housing portion is set so as to be shorter in the peripheral direction than the inner housing portion so that opposite end parts along the peripheral direction of the outer housing portion make contact with the opposite end parts along the peripheral direction of the elastic member when the elastic member has been deformed by being subjected to a centrifugal force at the time of high speed rotation.
